(19) United States
(12) Patent Application Publication
(10) Pub. No.: US 2025/0162150 A1
(43) Pub. Date: May 22, 2025

(54) ACTION PLANNING FOR ROBOT CONTROL

(71) Applicant: Bytedance Technology Ltd., Grand Cayman (KY)

(72) Inventors: Zhengyu CHEN, Los Angeles, CA (US); Shijie GENG, Los Angeles, CA (US)

(21) Appl. No.: 19/030,216

(22) Filed: Jan. 17, 2025

(51) Int. Cl. B25J 9/16

(52) U.S. Cl. CPC B25J 9/1664

(57) ABSTRACT

Embodiments of the disclosure provide a solution for action planning. A method includes: generating a sequence of images for an action execution plan based on description information and a reference image related to an environment with an action executor located, the description information describing the action execution plan to be executed by the action executor; extracting a sequence of visual feature representations from the sequence of images, respectively; and for a respective visual feature representation of the sequence of visual feature representations, determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

### FIELD

The present disclosure generally relates to computer technologies, and more specifically, to a method, apparatus, device and computer readable storage medium for action planning for robot control.

### BACKGROUND

In recent years, numerous studies have explored the use of a video diffusion model (VDM) to tackle various robotics challenges. VDM is configured to perform action prediction and is capable of forecasting actions for a robot over multiple timesteps. By predicting a series of consecutive actions, a robot may complete tasks more smoothly and stably. Most researches focus on short-horizon manipulation tasks involving single subtasks, such as “open the drawer” or “move the bottle.” However, in real-world applications, long-horizon manipulation tasks, which require completing multiple sequential subtasks, such as “open the microwave oven, pick up the food, and place the food into the oven”, are also common and present additional complexities.

### SUMMARY

In a first aspect of the present disclosure, there is provided a method for action planning. The method comprises: generating a sequence of images for an action execution plan based on description information and a reference image related to an environment with an action executor located, the description information describing the action execution plan to be executed by the action executor; extracting a sequence of visual feature representations from the sequence of images, respectively; and for a respective visual feature representation of the sequence of visual feature representations, determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

In a second aspect of the present disclosure, there is provided an apparatus for action planning. The apparatus comprises: an image generating module configured to generate a sequence of images for an action execution plan based on description information and a reference image related to an environment with an action executor located, the description information describing the action execution plan to be executed by the action executor; a representation extracting module configured to extract a sequence of visual feature representations from the sequence of images, respectively; and a control information determining module configured to, for a respective visual feature representation of the sequence of visual feature representations, determine control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: generating a sequence of images for an action execution plan based on description information and a reference image related to an environment with an action executor located, the description information describing the action execution plan to be executed by the action executor; extracting a sequence of visual feature representations from the sequence of images, respectively; and for a respective visual feature representation of the sequence of visual feature representations, determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

In a fourth aspect of the present disclosure, a computer-readable storage medium is provided. The computer-readable storage medium stores computer executable instructions which, when executed by an electronic device, causes the electronic device perform operations comprising: generating a sequence of images for an action execution plan based on description information and a reference image related to an environment with an action executor located, the description information describing the action execution plan to be executed by the action executor; extracting a sequence of visual feature representations from the sequence of images, respectively; and for a respective visual feature representation of the sequence of visual feature representations, determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of an architecture of the machine learning model in accordance with some embodiments of the present disclosure;

FIG. 3 illustrates a flowchart of a process for action planning in accordance with some embodiments of the present disclosure;

FIG. 4 shows a block diagram of an apparatus for action planning in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

A diffusion model, also known as a diffusion probability model, is a type of generative model. This model generates data by simulating the diffusion process. This process is inspired by physical processes such as thermal diffusion. The diffusion model includes forward diffusion process and reverse diffusion process. The diffusion model simulates a forward diffusion process that gradually adds noise and then learns how to reverse this process to generate new data samples.

In the forward diffusion process, noise is gradually added to the data, and through a series of steps, the data becomes increasingly random until it resembles pure noise. This process can be seen as a Markov chain, where Gaussian noise is added to the data at each step. The forward diffusion process can be expressed as: q(xₜ|xₜ₋₁)=N(xₜ; \sqrt{αₜ}xₜ₋₁, (1−αₜ)I), where xₜ is the noise data from step t, αₜ is used to control the amount of added noise. The forward diffusion process is performed during model training, and the data used to add noise is the training sample.

In the reverse diffusion process (or reverse denoising process), the model learns how to reverse the step of adding noise. Starting from pure noise, the diffusion model gradually removes the noise and generates data that matches the training distribution. The reverse diffusion process is typically simulated using a neural network that predicts the noise added at each step: p_{θ}(xₜ₋₁|xₜ)=N(xₜ₋₁; u_{θ}(xₜ, t), σ_{θ}(xₜ, t)), where u_{θ} and σ_{θ} represent learned model parameters. After completing the model training, the model that performs the backpropagation process can first sample from the noise distribution and iteratively denoise using until the desired data is obtained.

In the diffusion model, time step refers to the number of steps in which noise is added during the forward diffusion process. The total number of steps T is usually a predetermined value, indicating how many steps are required for the transition from raw data to pure noise. At each time step t, Gaussian noise is added to the data according to a predetermined noise scheme, which is continuous and dependent on the results of the previous step.

When generating data, the inference step of the diffusion model refers to the number of steps required to recover the original data from pure noise during the backward diffusion process. The number of reasoning steps directly affects the quality and speed of generating data. The more reasoning steps there are, the higher the quality of the generated data, but at the same time, it also increases computational costs and time. In practical applications, the balance between generation quality and efficiency can be achieved by adjusting the number of inference steps. In some embodiments, the inference steps correspond to time steps, and each inference step may correspond to one or more time steps. For example, if the total time steps of the diffusion model are 1000 steps and the inference steps are set to 50 steps, then each inference step may be considered as corresponding to 20 time steps.

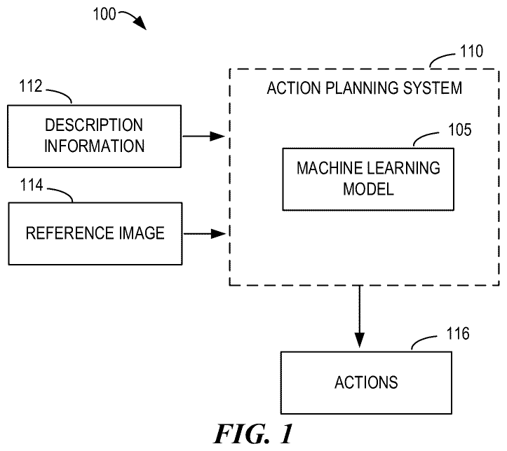

FIG. 1 illustrates a block diagram of an example environment 100 in which various embodiments of the present disclosure may be implemented. In the environment 100 of FIG. 1, an action planning system 110 applies a machine learning model 105 to perform action planning for a robot. The machine learning model 105 is configured to generate actions 116 based on description information 112 and a reference image 114. In some examples, the robot is located in an environment contained in the reference image 114 and the description information 112 may describe a plan to be performed by the robot.

In some embodiments, the machine learning model 105 may be constructed based on a planning algorithm. The planning algorithm may determine a series of feasible actions or paths in a given environment or task space based on the initial state of the robot, the target state of the robot, and a series of constraint conditions.

In some embodiments, the machine learning model 105 may be configured as any suitable type of models that is capable of generating content matching the model input. In some embodiments, the machine learning model 105 may be constructed based on a type of generative model. In some examples, the machine learning model 105 may be constructed based on a diffusion model.

In FIG. 1, the action planning system 110 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As briefly mentioned above, long-horizon manipulation tasks are complex. Long-horizon manipulation tasks present several key challenges because they involve multiple sequential tasks while short-horizon manipulation tasks only involve a single task. First, the multiple sequential tasks require robots to execute multiple subtasks in sequence, where any failure in an earlier step result in subsequent failures. This causes either robust error recovery mechanisms or high accuracy at certain steps. Second, since multiple subtasks occur within the same environment, observations of a robot across these subtasks can often appear similar. For instance, in the “put food into microwave” example, the observations between picking up the food (e.g., step 1) and placing it in the microwave (e.g., step 2) differ mainly in the food's presence in the robot's grasp. Such subtle variations complicate imitation learning approaches rely heavily on current observations only.

VDM has shown potential as visual planners for long-horizon tasks. However, implementations of VDM translate predicted images directly into actions without ensuring that each subgoal is achieved. While these open-loop control approaches may be adequate for short-horizon tasks, small deviations in long-horizon tasks may result in substantial divergence from the original plan.

A solution is proposed to combine VDM-based high-level visual planning with a goal-conditioned low-level policy. Here, the VDM generates a high-level action plan, while the low-level policy follows a closed-loop process to sequentially achieve these sub-goals, only advancing to the next subgoal upon completion of the current one. However, the low-level policy of the recent work, which consumes only one subgoal at a time, does not effectively mitigate challenges related to similar observations in long-horizon tasks. Moreover, the recent work treats all subgoals equivalently, overlooking that some subtasks, like picking up food in the microwave example, demand higher precision compared to others, such as moving the food.

In some other solutions, VDMs aim to generate high-quality videos that maintain temporal consistency while adhering to specific conditions, such as images, text, camera angles, and human poses. Recent advancements in this field have focused on enhancing efficiency, quality, and controllability. In an example, sparse control signals, such as sketches, depth maps, or RGB images, may be incorporated. This approach enables video generation control without the need to modify the pre-trained text-to-video model. In another example, precise control over both appearance and motion is allowed by separating the video generation into distinct spatial and motion modules. Furthermore, another related work enhance customized generation by dividing the task into subject learning and motion learning stages, allowing for customization of both the subject's identity and its motion.

Recently, there has been a growing trend in using diffusion models as visual planners to generate goal states for robotic manipulation. A related work begins by generating a video based on textual descriptions of tasks to predict the agent's trajectory for achieving a specific goal. The generated video is then processed by an inverse dynamics model to extract the necessary low-level control actions. Another related work utilizes a pretrained image-editing model for generating an image as a future subgoal based on language commands, followed by a low-level policy for executing the actions required to achieve the subgoal. While effective for short-horizon manipulation tasks, these methods struggle with long-horizon tasks involving long-horizon tasks containing many actions and complex scenes, such as changing camera views and articulation interactions.

Embodiments of the present disclosure propose an improved solution of action planning. In this solution, a sequence of images for an action execution plan is generated based on description information and a reference image related to an environment with an action executor located. The description information describes the action execution plan to be executed by the action executor. A sequence of visual feature representations is extracted from the sequence of images, respectively. For a respective visual feature representation of the sequence of visual feature representations, control information for controlling an action to be executed by the action executor in the environment to complete the action execution plan is determined at least based on the respective visual feature representation, a reference visual feature representation prior to the respective visual feature representation in the sequence and observed information of the action executor in the environment during execution of a reference action prior to the action.

With these embodiments of the present disclosure, the sequence of images for the action execution plan are generated as multi-subgoal for the action execution plan. Furthermore, actions to be executed by the action execution plan may be determined based on the sequence of images and observed information of the action executor. The observed information may indicate the current environment where the action executor is located. In this way, more accurate control for the action executor may be achieved.

Example embodiments of the present disclosure will be described with reference to the drawings.

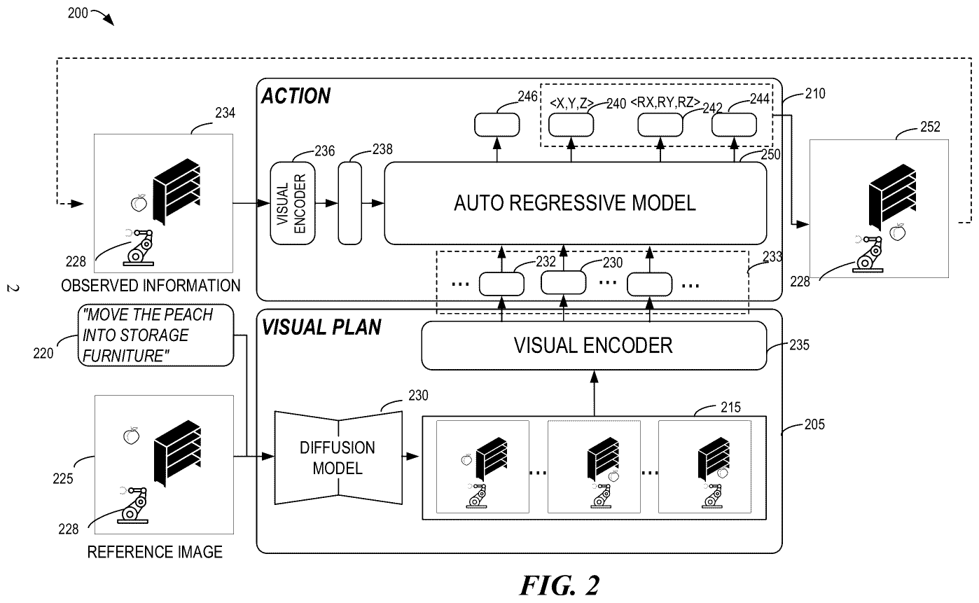

FIG. 2 illustrates a schematic diagram of an architecture 200 of the machine learning model 105 in accordance with some embodiments of the present disclosure. As shown in FIG. 2, in the example embodiments of the present disclosure, the machine learning model 105 may be constructed to include a visual planning sub-system 205 and an action sub-system 210.

In some embodiments, the visual planning sub-system 205 may be configured to generate future frames for a plan (also referred to as visual plans) as subgoals based on a reference frame (e.g., first frame) of the plan and a description of the plan. In some embodiments, the action sub-system 210 may be configured to determine actions to be executed by an action executor 228 based on the visual plans and observed information of the action executor. The action executor 228 may be controlled to execute a plurality of actions to perform a task. In an example, the action executor 228 may include an end effector of a robot. The end effector may be controlled to move an object to a position. In another example, the action executor 228 may include a steering wheel and an accelerator of an autonomous vehicle. The steering wheel and the accelerator may be controlled to overtake another vehicle. It would be appreciated that the action executor 228 may be any suitable physical device that is controllable for action execution. The scope of the embodiments of the present disclosure is not limited in this regard.

In the visual planning sub-system 205, a sequence of images 215 is generated for an action execution plan (sometimes referred to as task) based on description information 220 (sometimes referred to as text prompt) and a reference image 225 (sometimes referred to as initial frame) related to an environment with an action executor 228 located. The description information 220 may describe the action execution plan to be completed by the action executor 228. For example, the action execution plan may be related to moving an object (e.g., a peach) to a certain position, and the description information 220 may be “moving the peach into the storage furniture”. The reference image 225 may be related to the environment including the action executor 228 and the related objects (e.g., the peach and the storage furniture).

In some embodiments, in the visual planning sub-system 205, a trained diffusion model 230 may take the description information 220 and the reference image 225 as input, and generate the sequence of images 215. In some examples, the last image of the sequence of images 215 may indicate the action execution plan has been completed. In the example of the action execution plan related to moving the peach into the storage furniture, the last image of the sequence of images 215 may indicate the peach has been moved into the storage furniture.

In some embodiments, the reference image 225 may include an RGB image or an image in any other suitable format. In an example, given an image I₀ as the reference image 225, and the description information 220, the diffusion model 230 may generate a video output (e.g., the sequence of images 215) including T images {I₁, I₂, . . . , I_{T}}. The sequence of images 215 may visually show the process of performing the action execution plan by the action executor in the environment. Thus, these generated images may function as subgoals to help the robot in performing its manipulation tasks (e.g., moving the peach into the storage furniture).

In some embodiments, a depth image for the reference image 225 may be additionally used as a condition for generating the sequence of images 215. Each pixel value in the depth image may correspond to the distance of the closest object in the scene to the camera plane at that pixel's location. In this way, the extraction of three-dimensional spatial information from the scene may be enabled and the sequence of images 215 may better abstract features of the reference image 225.

In some embodiments, the diffusion model 230 may include one or more diffusion transformer blocks, or may be constructed with other diffusion model structure. A diffusion transformer block may be a neural network structure that includes several key components designed to process sequential data, such as text, speech, and other time-series information, using the attention-based mechanism. By stacking a plurality of diffusion transformer blocks, the diffusion model 230 may be capable of processing complex sequence processing tasks.

In some embodiments, the diffusion model 230 may be trained based on images sampled from a training sample. The training sample includes a video associated with an action executor executing actions. In some examples, the diffusion model 205 may include a text-to-image backbone pre-trained based on pretraining data (e.g., a high-quality image dataset). Then, the text-to-image backbone may be fine-tuned based on images sampled from the training sample which may include a video associated with an action executor executing actions. The video may be related to an environment which includes a container (e.g., storage furniture), an action executor (e.g., gripper), a goal object (e.g., peach), and a distractor object. In this way, the domain gap between the pretraining data and the training sample may be reduced and the quality of the images generated by the diffusion model 230 may be improved.

In some embodiments, the diffusion model 205 may comprise a motion module constructed based on a transformer block (e.g., temporal transformer block) and the transformer block may include several self-attention blocks along the temporal axis. The motion module may be configured to extract motion feature representations from actions executed by the action executor based on the training sample. In some examples, the motion module may operate along the temporal axis, to learn general motion priors (also referred to as motion feature representations) from the video in the training sample. To prevent undesirable effects, output projection layers of the motion module may be initialized to zero and a residual connection may be added, thereby ensuring that the motion module acts as an identity mapping at the beginning of training. In this way, the diffusion model 205 may generate high-quality videos in the same domain as the training videos (e.g., the domain of robotics).

In some embodiments, the diffusion model 205 may further be trained by sparse control technique. In some examples, an add-on encoder network upon the diffusion model 205 may accept additional temporally sparse conditions (e.g., the description information 220) for a specific key frame (e.g., the reference image 225). In this way, the diffusion model 205 may generate a video that accurately follows the description information 220 while conditioning on the reference image 225.

After the sequence of images 215 is generated, a sequence of visual feature representations 233 (also referred to as visual plan tokens) may be extracted from the sequence of images 215, respectively. In some embodiments, a visual encoder 235 in the visual planning sub-system 205 may take the sequence of images 215 as input and generate the sequence of visual feature representations 233. In some examples, the visual encoder 235 may be constructed based on a transformer, convolutional neural networks (CNN), recurrent neural network (RNN) and the like, which is suitable for visual feature extraction.

The sequence of visual feature representations 233 are then used to guide generation of actions to be executed by the action executor 228. In the action sub-system 210, for a respective visual feature representation of the sequence of visual feature representations 233, control information for controlling an action to be executed by the action executor 228 in the environment to complete the action execution plan is determined. The determination of the respective action is at least based on the respective visual feature representation, a reference visual feature representation prior to the respective visual feature representation in the sequence and observed information of the action executor in the environment during execution of a reference action prior to the action. That is, for each visual feature representation in the sequence of visual feature representations 233, respective control information may be determined for the visual feature representation.

The reference visual feature representation refers to a visual feature representation prior to the respective visual feature representation in the sequence 233 which is considered as a reference when determining an action corresponding to the respective visual feature representation. For example, if the respective visual feature representation is the fourth visual feature representation in the sequence 233, the reference visual feature representation is the third visual feature representation in the sequence 233. Furthermore, the reference visual feature representation may indicate an expected observation of the action executor 228 in the environment during execution of the reference action. The observed information may indicate an actual observation of the action executor 228 in the environment during execution of the reference action. By referring to both the expected observation and the current actual observation during the action prediction, it enables the model to generate more accurate control information for controlling the action of the action execution 228.

Based on a difference between the reference visual feature representation and the respective visual feature representation, expected actions to be executed by the action executor 228 may be determined to achieve the state of the respective visual feature representation. In addition, the expected actions may be adjusted based on the actual environment information (i.e., observed information) of the action executor 228. Therefore, the probability of achieving the state of the respective visual feature representation may be improved. In an example, for a third visual feature representation 230 of the sequence of visual feature representations, the control information may be determined based on the third visual feature representation 230, a second visual feature representation 232 prior to the third visual feature representation 230 of the sequence 233 and an observed feature representation 238. The observed feature representation 238 may be extracted from observed information 234 by a visual encoder 238 and the observed information 234 may indicate the environment during execution of the reference action prior to the action determined for the second visual feature representation 232. The observed information 234 may include positions of the action executor 228 and other objects. In some examples, the observed information 234 may be captured by a camera associated with the action executor 228. If the action executor 228 is a gripper of a robot, the camera and the gripper may be installed together on the robot. In some examples, the observed information 234 may be captured by a separate camera. In this way, the current environment information of the action executor 228 may be informed to the action sub-system 210 and thus more accurate control for the action executor 228 may be achieved by considering the current environment information (e.g., current position, velocity, acceleration, etc.) of the action executor 228.

In some embodiments, the control information may include a start position 240 (denoted as <X, Y, Z>) of the action executor 228, an orientation 242 (denoted as <RX, RY, RZ>) for the action executor 228 to move to a destination position from the start position 228, and a motion 244 performed by the action executor 228. The action to be executed by the action executor 228 may be determined based on the start position 240, the orientation 242 and the motion 244. In some examples, the action may include a movement indicating where the action executor 228 moves to and a specific motion 244 performed by the action executor 228. The movement may be determined based on the start position 240 and the orientation 242. The motion 244 may include grip, weld, assembly and the like.

In some embodiments, the control information may be determined by an auto-regressive model 250. In some examples, the auto-regressive model 250 may be constructed based on a causal transformer. The auto-regressive model 250 may take the respective visual feature representation, the reference visual feature representation, observed information and reference control information determined for controlling the reference action as input and generate the control information. In this way, the auto-regressive model 250 may capture the underlying causal dependencies in the action execution plan by predicting the control information and thus more accurate control for the action executor 228 may be achieved.

In some embodiments, the reference control information may include coordinate information 246 (also referred to as pixel coordinates) of a predicted position of the action executor 228. The coordinate information is configured to guide the determination of the start position 240, the orientation 242 and the motion 244 for the action. The coordinate information is a 2-dimensional information directly bound to visual feature representations, which is easy to extract. The coordinate information in the reference control information may provide a 2-dimensional guidance of the start position 240, the orientation 242 and the motion 244 contained in the control information.

In some embodiments, the action executor 228 may be controlled to execute a respective action based on the control information determined for the respective action. Then, observed information 252 of the action executor 228 in the environment during execution of the current action may be obtained, for use as a reference in determining a following action of the action executor. In an example, based on the control information determined for the current action, the action executor 228 may be controlled to execute the action moving the object from a position to another position. The observed information after the action executor 228 executing the action may be obtained to determining the following action.

In some embodiments, if a first number (denoted as N) of actions may be determined for the action executor 228, the action executor 228 may be controlled to execute a second number (denoted as H) of actions among the first number of actions. The second number is less than the first number. In an example, 10 actions may be determined for the action executor 228, and the action executor 228 may be controlled to execute only 5 actions among the determined 10 actions. With these embodiments, the action executor 228 may be allowed to prepare for upcoming tasks or obstacles, which can improve efficiency and reduce the likelihood of errors. Furthermore, the action executor 228 is allowed to adapt to changes in its environment. In this way, the combination of predicting long and executing short allows for a balanced approach, leveraging the benefits of both anticipation and agility.

In some embodiments, after the second number of actions among the first number of actions are executed by the action executor 228, another first number of actions may be determined for the action executor 228. In the example of determining 10 actions and executing 5 actions, after executing the fifth action in the determined 10 actions, another 10 actions may be determined for the action executor 228.

In some embodiments, the action executor 228 may repeatedly execute the second number of actions among the first number of actions until the action execution plan is completed, e.g., the actions represented by the sequence of images generated by the diffusion model 230 are all completed.

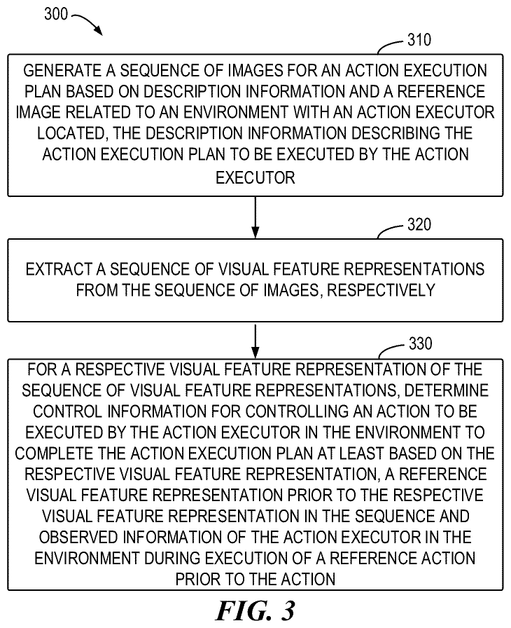

FIG. 3 illustrates a flowchart of a process 300 for action planning in accordance with some embodiments of the present disclosure. The process 300 may be implemented at the action planning system 110 of FIG. 1.

At block 310, the action planning system 110 generates a sequence of images for an action execution plan based on description information and a reference image related to an environment with an action executor located, the description information describing the action execution plan to be executed by the action executor.

At block 320, the action planning system 110 extracts a sequence of visual feature representations from the sequence of images, respectively.

At block 330, the action planning system 110, for a respective visual feature representation of the sequence of visual feature representations, determine control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

In some embodiments, the process 300 further comprises controlling the action executor to execute the action based on the determined control information; and obtaining observed information of the action executor in the environment during execution of the action, for use as a reference in determining a following action of the action executor.

In some embodiments, the control information comprises a start position of the action executor, an orientation for the action executor to move to a destination position from the start position, and a motion performed by the action executor, and the process further comprises: determining the action to be executed by the action executor based on the start position, the orientation and the motion.

In some embodiments, the control information is determined by an auto-regressive model, and determining the control information comprises: determining, using the auto-regressive model, the control information based on the respective visual feature representation, the reference visual feature representation, the observed information and reference control information determined for controlling the reference action.

In some embodiments, the reference control information comprises coordinate information of a predicted position of the action executor, which is configured to guide a determination of the start position, the orientation and the motion for the action.

In some embodiments, the process 300 further comprises in accordance with a determination that a first number of actions are determined for the action executor, controlling the action executor to execute a second number of actions among the first number of actions, the second number being less than the first number.

In some embodiments, the sequence of images is generated by a trained diffusion model based on the description information and the reference image.

In some embodiments, the diffusion model is trained based on images sampled from a training sample, the training sample comprising a video associated with an action executor executing actions.

In some embodiments, the diffusion model comprises a motion module constructed based on a transformer block, and the motion module is configured to extract motion feature representations from actions executed by the action executor based on the training sample.

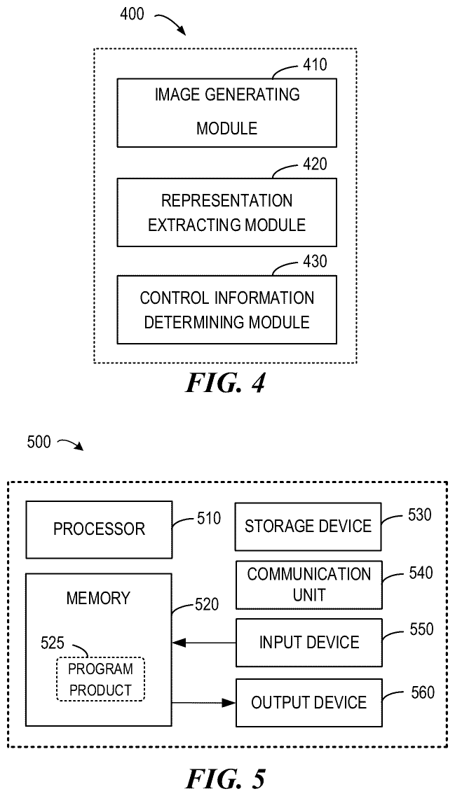

FIG. 4 shows a block diagram of an apparatus 400 for action planning in accordance with some embodiments of the present disclosure. The apparatus 400 may be implemented, for example, or included at the action planning system 110 of FIG. 1. Various modules/components in the apparatus 400 may be implemented by hardware, software, firmware, or any combination thereof.

As shown, the apparatus 400 includes an image generating module 410 configured to generate a sequence of images for an action execution plan based on description information and a reference image related to an environment with an action executor located, the description information describing the action execution plan to be executed by the action executor.

The apparatus 400 includes a representation extracting module 420 configured to extract a sequence of visual feature representations from the sequence of images, respectively.

The apparatus 400 further includes a control information determining module 430 configured to, for a respective visual feature representation of the sequence of visual feature representations, determine control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

In some embodiments, the apparatus 400 further includes a first controlling module configured to control the action executor to execute the action based on the determined control information; and obtain observed information of the action executor in the environment during execution of the action, for use as a reference in determining a following action of the action executor.

In some embodiments, the control information comprises a start position of the action executor, an orientation for the action executor to move to a destination position from the start position, and a motion performed by the action executor. The apparatus 400 further includes an action determining module configured to determine the action to be executed by the action executor based on the start position, the orientation and the motion.

In some embodiments, the control information is determined by an auto-regressive model. The control information determining module 430 is further configured to determine, using the auto-regressive model, the control information based on the respective visual feature representation, the reference visual feature representation, the observed information and reference control information determined for controlling the reference action.

In some embodiments, the reference control information comprises coordinate information of a predicted position of the action executor, which is configured to guide a determination of the start position, the orientation and the motion for the action.

In some embodiments, the apparatus 400 further includes a second controlling module configured to, in accordance with a determination that a first number of actions are determined for the action executor, control the action executor to execute a second number of actions among the first number of actions, the second number being less than the first number.

In some embodiments, the sequence of images is generated by a trained diffusion model based on the description information and the reference image.

In some embodiments, the diffusion model is trained based on images sampled from a training sample, the training sample comprising a video associated with an action executor executing actions.

In some embodiments, the diffusion model comprises a motion module constructed based on a transformer block, and the motion module is configured to extract motion feature representations from actions executed by the action executor based on the training sample.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the action planning system 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 600.

The electronic device 500 may further include additional removable/non-removable, volatile/non-volatile, transitory/non-transitory storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for action planning, comprising:
generating a sequence of images for an action execution plan based on description information and a reference image related to an environment with an action executor located, the description information describing the action execution plan to be executed by the action executor;
extracting a sequence of visual feature representations from the sequence of images, respectively; and
for a respective visual feature representation of the sequence of visual feature representations,
determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

2. The method of claim 1, further comprising:
controlling the action executor to execute the action based on the determined control information; and
obtaining observed information of the action executor in the environment during execution of the action, for use as a reference in determining a following action of the action executor.

3. The method of claim 1, wherein the control information comprises a start position of the action executor, an orientation for the action executor to move to a destination position from the start position, and a motion performed by the action executor, and the method further comprises:
determining the action to be executed by the action executor based on the start position, the orientation and the motion.

4. The method of claim 3, wherein the control information is determined by an auto-regressive model, and determining the control information comprises:
determining, using the auto-regressive model, the control information based on the respective visual feature representation, the reference visual feature representation, the observed information and reference control information determined for controlling the reference action.

5. The method of claim 4, wherein the reference control information comprises coordinate information of a predicted position of the action executor, which is configured to guide a determination of the start position, the orientation and the motion for the action.

6. The method of claim 1, further comprising:
in accordance with a determination that a first number of actions are determined for the action executor, controlling the action executor to execute a second number of actions among the first number of actions, the second number being less than the first number.

7. The method of claim 1, wherein the sequence of images is generated by a trained diffusion model based on the description information and the reference image.

8. The method of claim 7, wherein the diffusion model is trained based on images sampled from a training sample, the training sample comprising a video associated with an action executor executing actions.

9. The method of claim 8, wherein the diffusion model comprises a motion module constructed based on a transformer block, and the motion module is configured to extract motion feature representations from actions executed by the action executor based on the training sample.

10. An electronic device, comprising:
at least one processor; and
at least one memory coupled to the at least one processor and storing instructions executable by the at least one processor, the instructions, upon execution by the at least one processor, causing the electronic device to perform operations comprising:
generating a sequence of images for an action execution plan based on description information and a reference image related to an environment with an action executor located, the description information describing the action execution plan to be executed by the action executor;
extracting a sequence of visual feature representations from the sequence of images, respectively; and
for a respective visual feature representation of the sequence of visual feature representations,
determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

11. The electronic device of claim 10, the operations further comprising:
controlling the action executor to execute the action based on the determined control information; and
obtaining observed information of the action executor in the environment during execution of the action, for use as a reference in determining a following action of the action executor.

12. The electronic device of claim 10, wherein the control information comprises a start position of the action executor, an orientation for the action executor to move to a destination position from the start position, and a motion performed by the action executor, and the operations further comprises:
determining the action to be executed by the action executor based on the start position, the orientation and the motion.

13. The electronic device of claim 12, wherein the control information is determined by an auto-regressive model, and determining the control information comprises:
determining, using the auto-regressive model, the control information based on the respective visual feature representation, the reference visual feature representation, the observed information and reference control information determined for controlling the reference action.

14. The electronic device of claim 13, wherein the reference control information comprises coordinate information of a predicted position of the action executor, which is configured to guide a determination of the start position, the orientation and the motion for the action.

15. The electronic device of claim 10, the operations further comprising:
in accordance with a determination that a first number of actions are determined for the action executor, controlling the action executor to execute a second number of actions among the first number of actions, the second number being less than the first number.

16. The electronic device of claim 10, wherein the sequence of images is generated by a trained diffusion model based on the description information and the reference image.

17. The electronic device of claim 16, wherein the diffusion model is trained based on images sampled from a training sample, the training sample comprising a video associated with an action executor executing actions.

18. The electronic device of claim 17, wherein the diffusion model comprises a motion module constructed based on a transformer block, and the motion module is configured to extract motion feature representations from actions executed by the action executor based on the training sample.

19. A non-transitory computer readable storage medium having computer executable instructions stored thereon, the computer executable instructions, when executed by an electronic device, causing the electronic device perform operations comprising:
generating a sequence of images for an action execution plan based on description information and a reference image related to an environment with an action executor located, the description information describing the action execution plan to be executed by the action executor;
extracting a sequence of visual feature representations from the sequence of images, respectively; and
for a respective visual feature representation of the sequence of visual feature representations,
determining control information for controlling an action to be executed by the action executor in the environment to complete the action execution plan at least based on the respective visual feature representation, a reference visual feature representation prior to the respective visual feature representation in the sequence and observed information of the action executor in the environment during execution of a reference action prior to the action.

20. The non-transitory computer readable storage medium of claim 19, the operations further comprising:
controlling the action executor to execute the action based on the determined control information; and
obtaining observed information of the action executor in the environment during execution of the action, for use as a reference in determining a following action of the action executor.
